(19) United States
(12) Patent Application Publication
(10) Pub. No.: US 2022/0245677 A1
(43) Pub. Date: Aug. 4, 2022

(54) DE-DUPLICATION OF ONLINE ADVERTISING REQUESTS

(71) Applicant: Pubwise, LLLP, Atlanta, GA (US)

(72) Inventors: Dwight Ringdahl, Kennesaw, GA (US); Stephen F. Johnston, JR., Marietta, GA (US)

(21) Appl. No.: 17/589,618

(22) Filed: Jan. 31, 2022

Related U.S. Application Data
(60) Provisional application No. 63/143,855, filed on Jan. 30, 2021.

(51) Int. Cl. G06Q 30/02; G06F 16/215

(52) U.S. Cl. CPC G06Q 30/0275; G06F 16/215

(57) ABSTRACT

A method and system for de-duplicating bids for an advertising request in a real-time bidding online environment includes receiving an ad request from a requestor service and creating a fingerprint based on metadata of the ad request. The fingerprint is compared to pre-existing fingerprints within a database and if no match is found, an auction is conducted for bids from one or more ad buyers for the ad request. If a matching fingerprint is found within the database, the ad request may be designated as a duplicate and not submitted for auction or it may be further processed according to pre-determined criteria to determine whether exceptions are present to allow the ad request to be advanced for auction.

### RELATED APPLICATIONS

This application claims the benefit of the priority of U.S. Provisional Application No. 63/143,855, filed Jan. 30, 2021, which is incorporated herein by reference in its entirety.

### BACKGROUND

“Programmatic advertising” refers to software-based buying and selling of online ad spaces across electronic networks, such as advertising networks that use or interface with the Internet. Programmatic advertising enables the automatic purchase of electronic ad inventory that is offered across various advertising networks by digital advertisers in an efficient manner, typically in real-time with inventory offerings. RTB ad serving, through which advertisers place bids on impressions and almost instantly have their ads shown on publisher websites, is well known in the art. Typically, buyers of the ad space use a Demand Side Platform (DSP). Sellers of the ad space use a Supply Side Platform (SSP). Both the DSP and SSP can autonomously interact with a third entity called an exchange. The exchange hosts at least one exchange server that supports real-time bidding.

For a high-level overview of RTB, when a browser being used by a client (website visitor) navigates to a publisher website, the publisher's web server sends back HTML code that tells the browser where to access the desired content and how to format it. Part of the HTML code returned to the browser will include a coded link known as an “ad tag.” The publisher's Ad Server will return a tag that points to an RTB-enabled SSP, typically through a dynamic Javascript tag that passes information such as the publisher's ID, the site ID, and ad slot dimensions.

From there, the client, also referred to as the “website visitor”, calls the SSP server where the SSP reads that client's SSP cookie ID, which is likely already on their machine. Assuming the client already has that SSP's cookie on their machine, the SSP starts the auction by requesting bids from a host of demand sources, the DSPs, such as a trading desk. If the client does not have an SSP cookie on their machine, their ad inventory can technically still be auctioned, but since nothing is known about that client, the price will tend to be low and more related to the site context than to the client's attributes. For the DSPs to truly value the impression, they need to know something about who is going to see it. This is where the SSP cookie ID comes in—packaged with the bid request is the SSP's cookie ID, along with the URL the impression will deliver on, and what the current client's frequency is on that site. Rich data is the primary driver of higher bids, and the cookie ID is the mechanism through which data is associated to a client.

Beyond the information about the client, where the ad will appear, e.g., the URL, is also important. For example, advertisers are willing to pay a premium to reach website visitors on their first or second pageview on a site vs. their 50th page view for the simple fact that website visitors are less engaged with site content and more likely to respond to an ad during their first few page views.

Based on the website visitor (client) ID and URL, the DSPs value that impression and submit a bid back to the SSP as well as an ad redirect to send to the client should their bid win the auction. The SSP picks the winning bid and passes the DSP's redirect back to the client. From here the client calls the DSP, the DSP sends the client the marketer's ad server redirect, and client calls the marketer's ad server and the marketer serves the client the final ad.

In recent years, the programmatic advertising industry has grown at such a rapid pace that network resources required to handle the real-time bid request/response traffic have become overwhelmed by the traffic, causing network delays, poor computing and network performance, lack of access to suitable ads, inefficient placement of ads, poor use of advertising budgets, poor scalability, and generally poor overall performance. The network resources simply have difficulty handling the traffic that is coming from the RTB (real-time bidding) ad exchanges, and the DSP (demand-side platform) servers are unable to keep up with the increased traffic flow without adding expensive additional capacity, further diminishing the effective performance of the programmatic advertising environment at affordable capacity levels.

RTB ad exchanges already offer trillions of bid requests per month. For example, Boston-based DataXu, founder of the Open RTB consortium, previously had seen 40% annual increases in queries, but experienced a 100% increase in 2016, which it attributed to header bidding. MediaMath saw a 20% rise in queries in 2017, with averages fluctuating between 5 million and 6 million queries per second. As a result, the DSP servers are required to evaluate enormous volumes of traffic in search of relevant ad inventory. While the RTB ad exchanges are mostly managing their demand sources without traffic flow tools, the DSPs are burdened with computing cost and scale problems that they cannot solve on their own.

While the webpage is loading, the SSP reaches out to an exchange to sell space on the loading page based on both the page subject matter/content and the associated personal information for the user who is loading the page, based on the user's prior browsing history. The exchange can seek to auction the ad space to DSPs based on what is known about the user and the site itself. This may involve contacting other exchanges, which in turn may contact even more exchanges, significantly multiplying the number of potentially-interested bidders for the same ad space. Many of these exchanges may then contact the same DSP to place a bid on the available ad space. Extreme duplication of the ad request can result, with the DSP receiving large numbers of duplicate bids by the same exchanges for the same ad space. To illustrate, with only 10 interconnected partners passing the request once, the DSP may have to contend with 111 requests, of which only 1 can be won at any time. This problem is exacerbated when SSPs pass along the new request from connected partners to the SSP's partners. The number of requests can multiply tenfold, with 1111 total requests to the DSP and still only one winner being possible.

In general, the entire advertising technology suffers from inefficiencies based on the same advertising space being auctioned numerous times. An exchange may receive back and reauction the same ad request, ultimately submitting fifteen or more requests to a DSP for a single advertisement. This crushes the win rate of the exchange (since only one request can be the winner), causing DSPs to favor other exchanges.

Accordingly, the need remains for systems and methods within the programmatic advertising field that can improve their efficiency by de-duplicating online advertisement requests.

### SUMMARY

According to embodiments of the inventive approach, a system and method are provided to identify key metadata about bid requests which metadata can be used to facilitate the identification, and efficient handling, of “duplicates.” Duplicates are defined via a fingerprint, which can be any data available to the bid request that can uniquely identify the bid request. The fingerprint is configurable. Examples of common fingerprint candidates include page, width height, IP, and useragent. If another bid request has the same fingerprint, it is considered a duplicate. The first bid will be designated as the “Primary Bid Request”, and the source of the request will be deemed the “Primary Requestor.” Other bid requests that are not the Primary Bid Request will be treated as “Duplicate Bid Requests.” In some embodiments, the system will retain the Primary Bid Request, seek bids on that request, and return the received bids to the Primary Requestor. The Duplicate Bid Requests will be returned to their respective requestors. In some embodiments, the Duplicates can be held “open” rather than being returned immediately to the SSP. When the Duplicate is held open, the bid from the DSP can be returned as the bid for all duplicates back to the SSP.

The examples described herein specifically address technical problems and limitations present in the ad tech environment. The ecosystem has grown overly complex based on ad space being auctioned in a tangled web of exchanges that submit ad requests to one another for nested bidding.

In one example, a fingerprinting platform is used to de-duplicate ad requests to ensure that DSPs are not asked to bid repeatedly on the same impression. The platform can give exchanges increased win percentages by reducing the number of duplicate bids that are sent to DSPs and can respond back to exchanges with the same bid to determine who actually owns the inventory.

The inventive approach allows all requests to receive bids while reducing DSP side bids—there are limits on numbers of requests that can be sent to the DSP that get swallowed up by duplicate bids. The excess or duplicative requests will be ignored without bidding at that DSP. The results include a more manageable data flow and happier DSPs who are able to increase revenues.

The method can be performed by a system. The method can also be implemented based on code stored on a non-transitory, computer-readable medium, which is read and executed by a processor in a computing device. The inventive system and method may be a standalone piece of a network infrastructure that can operate outside of an exchange.

In one aspect of the inventive approach, a method de-duplicating bids for an advertising request in a real-time bidding online environment includes receiving an ad request from a requestor service; creating a fingerprint based on metadata of the ad request; determining if the fingerprint matches a pre-existing fingerprint within a database; if the fingerprint does not match a pre-existing fingerprint, writing the fingerprint to the database; holding an auction for bids from one or more ad buyers for the ad request associated with the fingerprint; before or after the auction, receiving one or more additional ad request from the requestor service or a separate service; creating an additional fingerprint for each of the one or more additional ad request; determining if the additional fingerprint matches a pre-existing fingerprint within the database and, if a match is determined, designating the one or more additional ad request as a duplicate request and withholding the duplicate request from the auction; comparing bids from the auction to identify a highest bid for the ad request associated with the fingerprint; and submitting the highest bid to the requestor service. In some embodiments, the fingerprint comprises a combination of elements of the metadata configured to verify a web site and a user and to define attributes of the ad request. The fingerprint may include a hash with at least two of an internet protocol (“IP”) address, uniform resource locator (“URL”), and a date and time. The database may reside in shared memory across multiple servers configured to receive ad requests. Bids received during the auction are stored in the database in association with the fingerprint. A no-bid may be stored in the memory database when the auction yields no bids, and wherein the highest bid is the no-bid.

In some embodiments, withholding the duplicate request from the auction may include waiting long enough for the auction to complete, wherein the highest bid is also sent to the separate service. The highest number of bids including the highest bid are communicated to the requestor service.

In some embodiments, a system processor may be configured to perform further processing wherein, if a match is determined, prior to withholding a duplicate request from an auction: designating the duplicate request as a provisional duplicate and further processing the provisional duplicate to determine whether exceptions have been configured by one or more of the requestor service or the one or more ad buyers; and if exceptions are found, advancing the provisional duplicate for inclusion in the auction. A user interface is configured by the requestor service to allow all provisional duplicates to be advanced for inclusion in the auction. The user interface may also be configured to allow provisional duplicates to advance to auction based on one or more of a timestamp within the fingerprint for the ad request, and a predetermined number of provisional duplicates.

In another aspect of the invention, a system for de-duplicating bids for an advertising request in a real-time bidding online environment includes a processor configured to execute instructions for de-duplicating ad requests, the instructions comprising: receiving an ad request from a SSP; creating a fingerprint based on metadata of the ad request; determining if the fingerprint matches a pre-existing fingerprint within a database; if the fingerprint does not match a pre-existing fingerprint, writing the fingerprint to the database; holding an auction for bids from one or more DSPs for the ad request associated with the fingerprint; before or after the auction, receiving one or more additional ad request from the SSP or another SSP; creating an additional fingerprint for each of the one or more additional ad request; determining if the additional fingerprint matches a pre-existing fingerprint within the database and, if a match is determined, designating the one or more additional ad request as a duplicate request and withholding the duplicate request from the auction; comparing bids from the auction to identify a highest bid for the ad request associated with the fingerprint; and submitting the highest bid to the SSP. The fingerprint may include a combination of elements of the metadata configured to verify a web site and a user and to define attributes of the ad request. In some embodiments, the fingerprint may be a hash comprising at least two of an internet protocol (“IP”) address, uniform resource locator (“URL”), and a date and time. The database may reside in shared memory across multiple servers configured to receive ad requests. Bids received during the auction are stored in the database in association with the fingerprint. A no-bid may be stored in the memory database when the auction yields no bids, and wherein the highest bid is the no-bid.

In some embodiments, withholding the duplicate request from the auction may include waiting long enough for the auction to complete, wherein the highest bid is also sent to the SSP. The highest number of bids including the highest bid are communicated to the SSP.

In some embodiments, a system processor may be configured to perform further processing wherein, if a match is determined, prior to withholding a duplicate request from an auction: designating the duplicate request as a provisional duplicate and further processing the provisional duplicate to determine whether exceptions have been configured by one or more of the SSP or the one or more DSP; and if exceptions are found, advancing the provisional duplicate for inclusion in the auction. A user interface is configured by the SSP to allow all provisional duplicates to be advanced for inclusion in the auction. The user interface may also be configured to allow provisional duplicates to advance to auction based on one or more of a timestamp within the fingerprint for the ad request, and a predetermined number of provisional duplicates.

In still another aspect of the invention, a method de-duplicating bids for an advertising request in a real-time bidding online environment includes receiving an ad request from a SSP; creating a fingerprint based on metadata of the ad request; determining if the fingerprint matches a pre-existing fingerprint within a database; if the fingerprint does not match a pre-existing fingerprint, writing the fingerprint to the database; holding an auction for bids from one or more DSPs for the ad request associated with the fingerprint; before or after the auction, receiving one or more additional ad request from the SSP or another SSP; creating an additional fingerprint for each of the one or more additional ad request; determining if the additional fingerprint matches a pre-existing fingerprint within the database and, if a match is determined, designating the one or more additional ad request as a duplicate request and withholding the duplicate request from the auction; comparing bids from the auction to identify a highest bid for the ad request associated with the fingerprint; and submitting the highest bid to the SSP. The fingerprint may include a combination of elements of the metadata configured to verify a website and a user and to define attributes of the ad request. In some embodiments, the fingerprint may be a hash comprising at least two of an internet protocol (“IP”) address, uniform resource locator (“URL”), and a date and time. The database may reside in shared memory across multiple servers configured to receive ad requests. Bids received during the auction are stored in the database in association with the fingerprint. A no-bid may be stored in the memory database when the auction yields no bids, and wherein the highest bid is the no-bid.

In some embodiments, a user interface may be configured by the SSP to allow all provisional duplicates to be advanced for inclusion in the auction. The user interface may configured to allow provisional duplicates to advance to auction based on one or more of a timestamp within the fingerprint for the ad request, and a predetermined number of provisional duplicates.

### BRIEF DESCRIPTION OF THE DRAWINGS

FIG. 1 is an example flow chart showing example stages for de-duplicating bids in response to the same ad request according to an embodiment of the inventive platform.

FIG. 2 is a sample sequence diagram showing steps for de-duplicating bids in response to the same ad request according to an embodiment.

FIG. 3 is an example illustration of system components in an exemplary platform.

FIGS. 4A-4C are diagrams of sample user interfaces for configuring processing of Provisional Duplicate requests based on SSP, global and DSP behavior, respectively.

FIG. 5 is a block diagram of an embodiment of the processor-based system that may be used to implement the inventive platform.

### DETAILED DESCRIPTION OF EMBODIMENTS

Definitions: The following is a glossary of terms that may assist the reader in understanding of the disclosure:

“Fingerprint” means a unique bid identifier that is based on any metadata present in or associated with the bid. Examples of fingerprint sources include request headers, ORTB (Open Real Time Bidding) bid, additional data enrichment, etc.

“Ad Impression,” or simply “Impression,” means the number of times an ad has been served, regardless of whether the user (client) has actually seen or interacted with the ad in any way.

“Supply Side Platform” or “SSP”, as used herein, means any source of bid requests for ad impressions, i.e., any entity that sells ads. This could be direct to device, a traditional SSP or a DSP acting as an SSP, and therefore will have a broader meaning that is conventionally applied to “SSP” in the industry. An alternative term for SSP is a “requester service”.

“Demand Side Platform” or “DSP”, as used herein, means any source of bid responses or purchases of ad impressions. Basically, a DSP can be any entity that buys ads. It should be noted that this definition is broader that the conventional meaning of “DSP” as used in the industry.

“Score” refers to the relative value of a bid request. The score can be used in later calculations.

“SCHAIN” means the SupplyChain Object that is part of an OpenRTB bid request and consists of “nodes”. Each node in the SCHAIN object represents a specific entity participating in the bid request, which includes all entities involved in the direct flow of payment for inventory.

“Multiplexing” means returning a single DSP bid to multiple SSPs based on the identification of duplicates.

“Bid” means an offer from a DSP to buy an ad. A bid can be single or multiple. A bid response back to an SSP can include any combination of DSPs and responses to various possible display configurations, without limitation.

“No-Bid” means any response from a DSP that indicates that it will not purchase an ad.

“Exchange” means any system sitting between SSPs and DSPs and orchestrating bids. For purposes of the present invention, a full exchange in the conventional sense is not required.

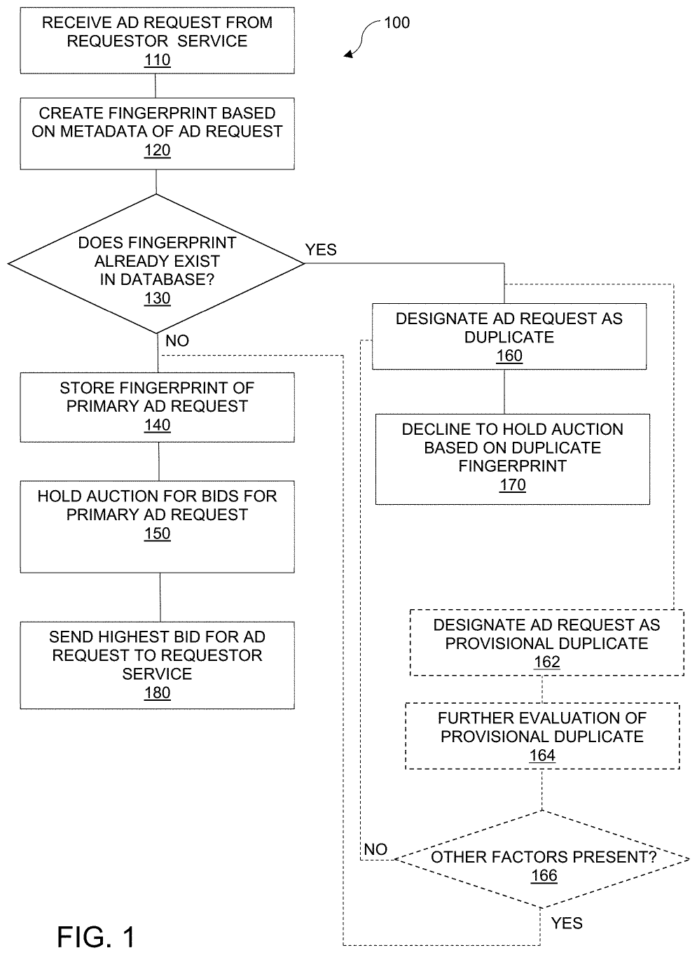

FIG. 1 illustrates the process flow 100 for an exemplary embodiment of the inventive method for de-duplicating ad requests. At step 110, the platform receives an initial ad request from a requestor service. The requestor service can be an SSP or an ad exchange. The requestor service can request a bid on an ad request from the platform.

The ad request may correspond to a webpage being loaded in real time on a user device. For example, the CNN website can include a 300×250 pixel ad space denoted by a tag that is supplied by an SSP (which can be CNN itself in that example). The ad request can essentially solicit bids to show the user on the webpage when it loads. The tag on the page can generate the ad request when the page loads. For example, when a user loads a webpage with the tag, the SSP can be contacted and can generate an ad request. Alternatively, the tag can directly contact an exchange or the platform with the ad request, or if can employ any path that reaches the system.

The ad request can include information about the webpage, browser, and user. For example, certain fields may be included as part of an ad tech standard, such as Open RTB or other standard. Any available metadata is a candidate. This can allow an exchange or the platform to verify the website and the user and perform analytics to determine attributes about either that can influence which demand-side buyer will submit the highest bid on the ad impression. For example, the uniform resource locator (“URL”) may be analyzed for specific (e.g., pre-determined) key words, geolocation can be translated into a particular geographic location, e.g., city or state, and/or cookie information can be considered to determine specific interests of the user.

After receiving the ad request (either from the SSP or an exchange), at step 120, the platform creates a fingerprint based on the metadata of the ad request to associate a unique identifier, i.e., a tag, with the ad request. Generally, any combination of metadata may be defined as a “fingerprint” (assuming, of course, that the same combination is used uniformly). In some implementations the fingerprint may be a hash based on fields of the ad request. In one implementation, the hash may include a combination, e.g., two or more, of an internet protocol (“IP”) address, URL, and a date and time. Some such fields can be standardized and essentially non-spoofable. Two or more of these standard fields can be used by the platform to create a hash. The hash serves as a fingerprint of the ad request, allowing the platform to determine when it receives duplicates of the same ad request (e.g., from other exchanges). Any combination can be used.

In step 130, the platform compares the fingerprint with others that may be stored in one or more associated database. This database can be remote or local, accessible by the various servers of the platform. The database can be made up of memory sectors of the various servers. The servers themselves can be exchange servers.

If the fingerprint is determined in step 130 to be new, the platform writes the fingerprint to the in-memory database in step 140. The absence of a pre-existing matching fingerprint in memory can indicate that this is first time the platform has seen the subject ad request, and the request is designated as a “Primary”.

Since this is a new ad request, at step 150, the platform initiates an auction for bids for the subject ad request associated with the fingerprint. This can include reaching out to one or more DSPs to retrieve bids on the ad request. DSPs can be ad tech platforms that allow buyers to automatically bid on the ad impression. The goal of the auction can be to determine the highest bid for the ad request. The bids can be stored and/or associated with the fingerprint in the in-memory database. The auction can conclude after a threshold amount of time, such as 70 ms. The ad corresponding to the winning bid can then be sent for placement on the webpage at the location specified by the SSP ad tag. This can all happen over a period of as little as 100 ms, including data transit time, while the webpage loads. Timing is variable and is not critical.

As the auction is taking place, additional exchanges may contact the platform with various ad requests, restarting the process at step 110. The platform may receive these additional ad requests from one or more separate services and in step 120, creates new fingerprints for each of the additional add requests. In step 130, the platform compares the new fingerprints to those previously saved in memory and determines whether they are unique or whether they match an existing fingerprint. If they are determined to be duplicates, in step 160, the ad request can be designated as a “Duplicate”.

In some implementations, when a new fingerprint is determined to match a fingerprint that already exists in memory, i.e., a Primary, rather than simply designating the new ad request with the matching fingerprint as a Duplicate and rejecting it from further consideration, the new fingerprint can be designated a “Provisional Duplicate” in step 162, after which additional analyses can be performed in step 164 to determine whether certain exceptions should be applied to requests initially designated as duplicates to allow the ad request to advance to auction. These exceptions can be pre-selected by the SSP, DSP or globally through user interfaces.

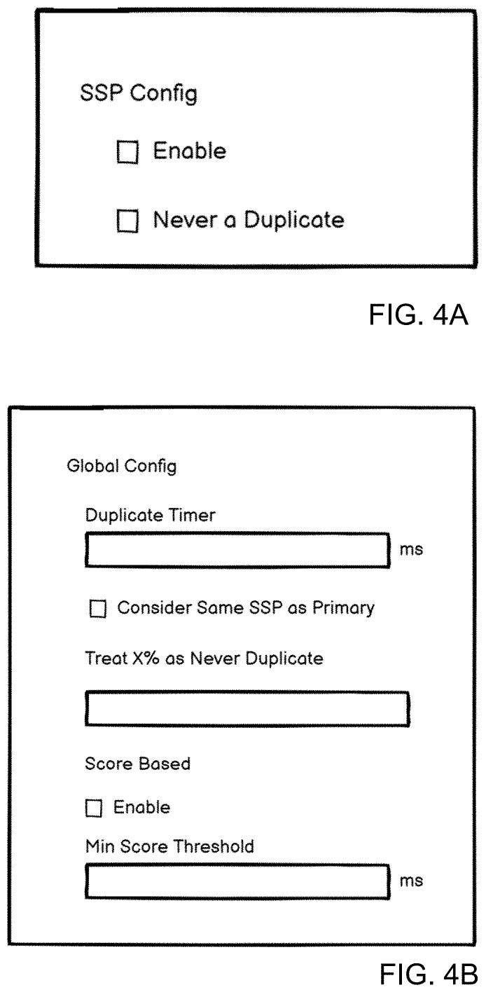

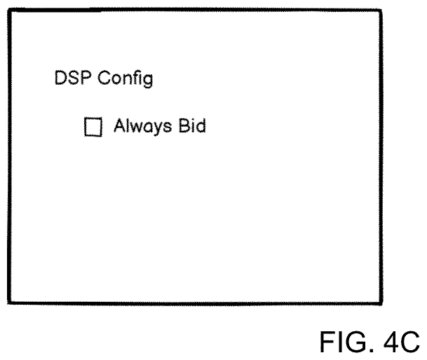

According to a first variation of the provisional duplicate evaluation, the fingerprints may be configured to incorporate the SSP information from the metadata. If the SSP in the fingerprint of the Provisional Duplicate request is the same as the SSP in the Primary Request, the bid request will be treated as a Primary Request. Referring briefly to FIG. 4A, this variation is configurable via the SSP user interface (UI) as shown, by checking “Enable” to enable the SSP Config, allowing all bids from that SSP to be considered for this functionality. If not enabled, all requests from that SSP are considered PRIMARY. Checking “Never a Duplicate” will configure the process so that a bid request from the same SSP will never be considered a duplicate. In step 166, the identity of the SSP is a factor that can be used to determine that the ad request is a Primary Request, which will then be routed to step 140 et seq. for bidding. If the SSPs are not the same, the Provisional Duplicate will be routed to step 160 and designated as a Duplicate.

In another variation, in step 164, the Provisional Duplicate can be evaluated for length of retention. In this scheme, the fingerprint can include timestamp data within the metadata of the ad request, indicating when the request was received. This allows millisecond timing configurations by interrogating the number. If a Provisional Duplicate returns with timing outside of the UI configurable value, the ad request will be considered a Primary. FIG. 4B illustrates a sample user interface for configuring values for the timer that determines whether or not a request is a duplicate. While the timestamp provides one example of this approach, any randomization algorithm may be used. For example, a pacing algorithm could involve specifying a certain quantity of time within a longer period of time, e.g., the first x seconds of each minute, or hour, or simply x seconds per hour. This UI provides for Provisional Duplicate processing to be configured for global behavior and includes the ability to select the previously-described variation regarding all ad requests from the same SSP being considered “Primary.”

Another variation for dispositioning of Provisional Duplicates, selectable via the Global Config UI shown in FIG. 4B, is to randomly treat some percentage of ad requests as “Never Duplicate.” If a Provisional Duplicate falls within the designated percentage, the ad request will be advanced for further processing and auction.

Another configuration for processing of Provisional Duplicates is selectable via the UI shown in FIG. 4C. In this variation, the dispositioning of a Provisional Duplicate based on the behavior of the DSP. Checking the box in the UI causes all ad requests to be designated as “Primary”. In this case, there will be a reduced set of bids on the backend.

According to some embodiments, the process for evaluating Provisional Duplicates for further consideration looks at timing as the key basis for determining which request is the “Best” request to respond to—i.e., the “first-in” is deemed a Primary. While this may be a useful approach, it is not complete. Further, this approach has no system for determining whether a bid is better (preferred) other than the first-in approach. To augment this method, the system may consider SCHAIN depth as an indicator and allow for scoring from external sources. In one implementation, the Primary bid can be replaced before the bid response comes back from the DSP, which will change the ad request to which a response will be made. The procedure can be based on one or a combination of factors. A first factor is a score generated by a third party system, in which a higher score replaces a lower score. A “score” can be any heuristic to indicate a “preferable” bid. For example, variables may be combined to generate an algorithm that calculates a likelihood that the ad will generate greater income. Such algorithms may be user-determined, or they may be based on machine learning, updated over time as more data is collected. Another approach may be to treat any score above a pre-determined threshold as a Primary, or conversely, to treat any score below a threshold as a Duplicate, which effectively blocks the request. The score from any source (external or part of the flow of the de-duplication scheme) may be stored in EXT fields on the ad request, or as any other extensible portion of the ad request, assuming that the method is adopted as a standard for generating fingerprints for all requests. This behavior can be configured in the user interface, an example of which can be seen in the lower portion of the Global Config shown in FIG. 4B.

Referring again to FIG. 1, at step 170, after determining that an ad request is a duplicate, the platform may decline to conduct an additional auction for the Duplicate ad(s). The platform can simply wait a threshold amount of time to allow the auction in step 150 to finish. This ensures that the platform does not solicit bids from the same DSP twice (or more) for the Primary and Duplicate ad requests.

In some embodiments, the system may retain the Primary Bid Request, seek bids on that request via auction (step 150), and return the received bids to the Primary Requestor. The Duplicate Bid Requests will be returned to their respective requestors.

In some embodiments, the Duplicates may be held “open” for a specified period of time instead of being returned immediately to the SSP. This open period may correspond to the amount of time required to complete the initial auction (step 150) and determine the highest bid, after which the highest bid is returned to the SSP. When the Duplicate is held open, the bid from the DSP can be returned to the SSP as the bid for all duplicates. This feature can be implemented by selecting a combination of configurations that may be added to both the SSP (FIG. 4A) and DSP (FIG. 4C) Config UIs to “Allow Multiplexing”.

When the auction in step 150 ends, the highest bid for the ad request can be sent to all of the requestors (e.g., the requestor service and any separate services that sent duplicate ad requests). In step 180, the max bid then will be communicated to the SSP that provided the Primary Request, which will place the corresponding advertisement on the webpage. In addition to reporting the highest bid, information provided to the requestor service/SSP may include the highest number of bids made during the auction. If a DSP responds to the auction with a “no-bid”, the platform may cache such a no-bid response as it would with any other response to an ad request. In situations where no DSPs bid on the ad request, the lack of any bids may be recorded in memory in association with Primary and/or multiplexed to the Duplicates.

As there are generally multiple DSPs involved in the auction, there will likely be multiple bids for a given ad request, however, those bids may be for different variations of the ad, for example, sizes, placements, configurations, etc. Multiple DSPs may respond with bids which can be returned to the SSP as a single highest bid from all bids, or as a number of higher bids that specify, for example, different display configurations. This can be an implementation decision or a UI configuration on the SSP side, i.e., “Return All Bids”. Thus, the SSP specify which bids it receives by specifying “single” or “multiple” and from any combination of DSPs and responses to various possible display configurations.

The following provides an illustrative sequence in an implementation of the inventive system in which a hash is used as the fingerprint to uniquely identify bid requests. The sequence begins with receipt of an ad request from an SSP or exchange:

Make a hash based on multiple of standard fields included in all ad requests
a. OpenRTB standard (or any standard) can specify which fields these are
b. Example fields: IP address, datetime, browser, URL (preference for fields that cannot be spoofed—tag to exchange, exchange to platform)
c. Sent to exchange from the publisher of the request
d. The platform can create the hash prior to beginning an auction with exchange functionality (can be the same or different servers)
e. Look up hash in in-memory database (is it a duplicated ad request?)
f. If not found, we write hash into the in-memory database
   i. Put hash into in-memory database
      1. Accessible by multiple servers
      2. Aerospike can be used
      3. Or each exchange server can give up their memory to make the database
      4. The servers can be exchange servers
   ii. Hold auction to acquire bids (platform's ad exchange service)
      1. Store bids to in-memory database
      2. If no bids, store a no-bid in in-memory database
      3. Send bids (or no-bid) to requestor (to the original exchange)
g. If found, the platform waits
   i. A pre-determined amount of time (e.g., 25 ms), or until the initial auction is completed
   ii. The platform calls back to in memory database with the hash for ad bids (This is asking “has anyone bid on this yet?”) (mem database collects bids also)
      1. If yes, we send those bids
      2. If no, then we send a no bid back to the exchange

Among the benefits provided by the inventive approach include that the platform offers exchanges, SSPs, and other sources increased win percentages by reducing the number of duplicate bids that are sent to DSPs. The platform also can respond back to exchanges with the same bid to determine who actually owns the inventory allowing the original requestor to be properly credited.

The inventive approach allows all requests to receive bids, while limiting the number of requests that might be sent to the DSP only to be overwhelmed by duplicate bids. The excess or duplicative requests will be ignored without bidding at that DSP. The results include a more manageable data flow and happier DSPs who are able to increase revenues.

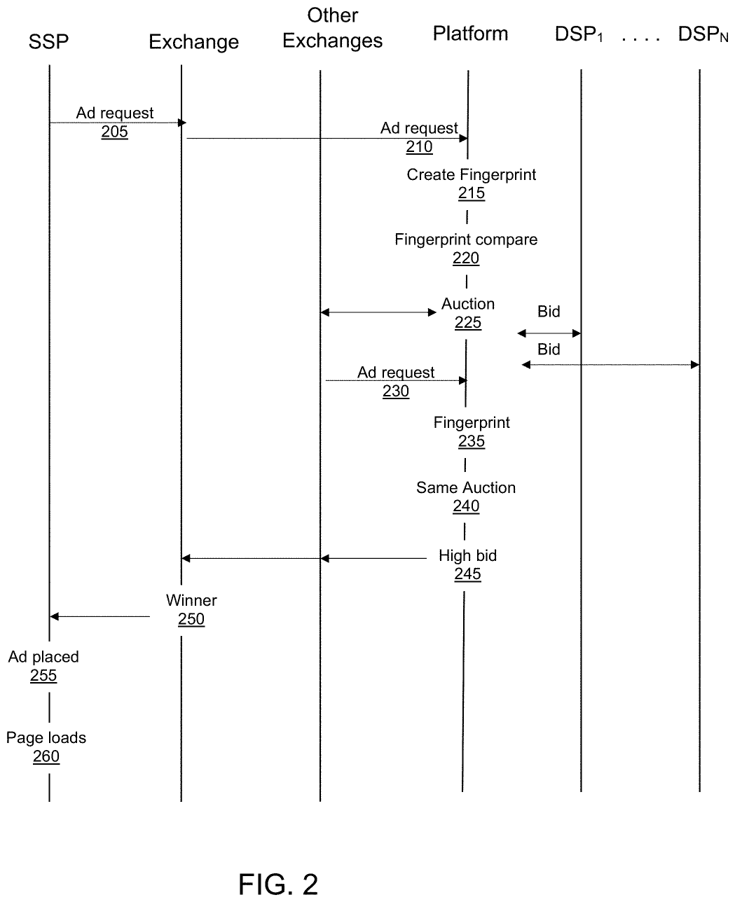

FIG. 2 illustrates an example sequence diagram of method steps performed in an example. At step 205, an ad request can be generated from an SSP's tag on a webpage that is loading for a user. The exchange can be the inventive platform or at step 210 can send the ad request to the platform after performing analytics to validate the ad request.

At step 215, the platform generates a fingerprint based on a combination of selected metadata of the ad request. Incorporated into the fingerprint will be a date/time field to indicate when the ad request was created. Since the same tag can create thousands or even millions of ads (i.e., each time a user visits the webpage), the datetime field can be important for distinguishing between multiple requests.

At step 220, the platform compares the fingerprint to determine whether it already exists in the in-memory database. If so, the platform can skip to step 240. Alternatively, it can perform additional Provisional Duplicate evaluation as described with reference to FIG. 1. If not a Duplicate, the platform can add the fingerprint to the database. Next, at step 225, the platform initiates an auction for the ad request of step 205. This can include soliciting bids from multiple DSPs (i.e., DSP₁ to DSP_{N}) and other exchanges. In some cases, the other exchanges may end up recirculating the same ad request to the platform at step 230, causing the platform to generate additional fingerprints for the additional ad requests received from the other exchanges at step 235. These new fingerprints will be evaluated and compared to determine whether they match the fingerprint for the Primary request. The requestors (e.g., other exchanges) that sent duplicate ad requests at step 230 may still be associated with the auction of step 225 at step 240.

At step 245, the auction can end with receipt of a high bid. The platform can send the high bid for the ad request to all of the requestor services (e.g., the exchange and any of the other exchanges that sent a duplicate ad request). The winner can be selected by the original exchange at step 250. The winning bidder's ad may then be placed on the webpage at step 255 as the page loads at step 260.

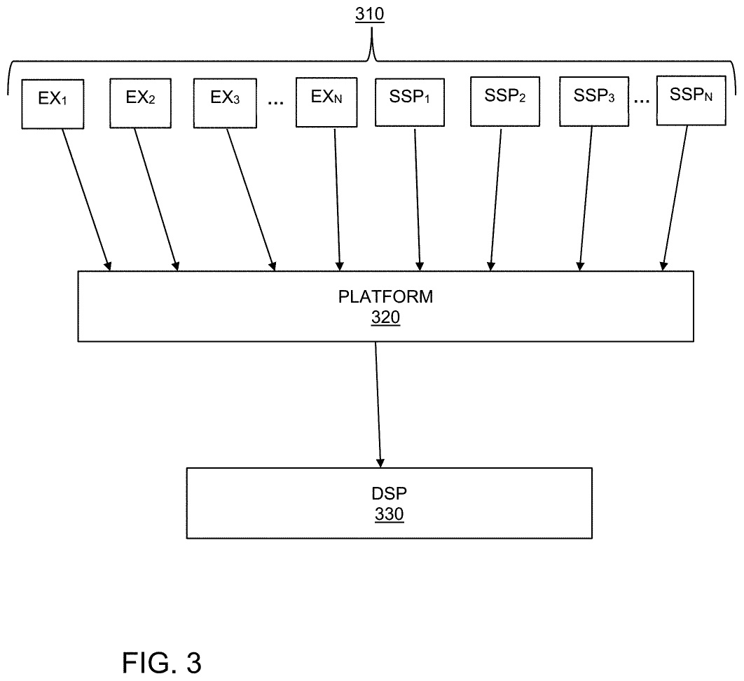

FIG. 3 is an illustration of example system components in one implementation of the inventive system. The services 310 can be exchanges (EX₁, EX₂, . . . , EX_{N}) or SSPs (SSP₁, SSP₂, . . . , SSP_{N}) that communicate ad requests to the platform 320. The platform 320 can execute as hundreds of synchronized servers, in an example. The platform 320 can receive duplicate ad requests from any number of requestor services 310, yet send only one of that ad request to a given DSP 330. This can greatly increase win rates with the DSP, causing the DSP to prioritize bids that come through the platform 320, in an example.

As will be apparent to those in the art, the inventive de-duplication scheme is not limited an a conventional “exchange”, but may be a standalone part or module within a network infrastructure.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

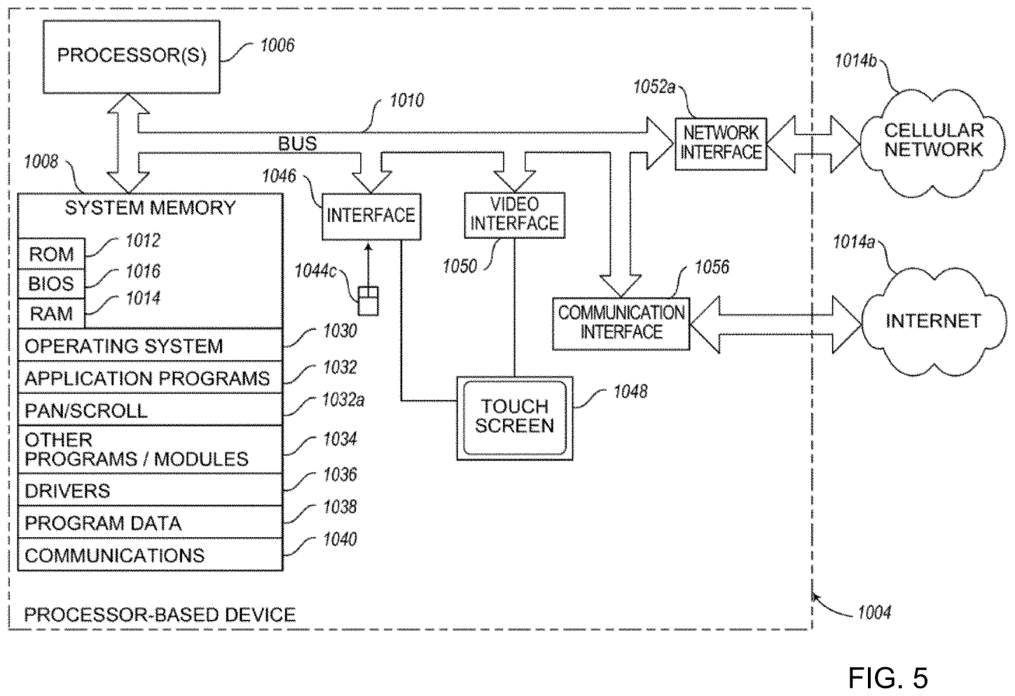

FIG. 5 illustrates an example of a processor-based system 1000 that may be used to implement embodiments of the inventive platform described herein. Some embodiments may be described in the general context of processor-executable instructions or logic, such as program application modules, objects, or macros being executed by one or more processors. Those skilled in the relevant art will appreciate that the described embodiments, as well as other embodiments, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based system may, for example, take the form of a smartphone or tablet computer, which includes one or more processors 1006, a system memory 1008 and a system bus 1010 that links various system components including the system memory 1008 to the processor(s) 1006. The system 1000 may be a single system or more than one system or other networked computing device.

The processor(s) 1006 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 5 are of conventional design. As a result, such blocks need not be described in further detail herein, as they will be understood by those skilled in the relevant art.

The system bus 1010 can employ any known bus structures or architectures, including a memory bus with memory controller, a peripheral bus, and a local bus. The system memory 1008 includes read-only memory (“ROM”) 1012 and random access memory (“RAM”) 1014. A basic input/output system (“BIOS”) 1016, which can form part of the ROM 1012, contains basic routines that help transfer information between elements within system 1000, such as during start-up. Some embodiments may employ separate buses for data, instructions, and power.

The system 1000 may also include one or more solid state memories, for instance Flash memory or solid state drive (SSD) 1018, which provides nonvolatile storage of computer-readable instructions, data structures, program modules and other data for the system 1000. Although not depicted, the system can employ other non-transitory computer- or processor-readable media, for example a hard disk drive, an optical disk drive, or memory card media drive.

Program modules can be stored in the system memory 1008, such as an operating system 1030, one or more application programs 1032, other programs or modules 1034, drivers 1036 and program data 1038.

The system memory 1008 may also include communications programs 1040, for example a server and/or a Web client or browser for permitting the system 1000 to access and exchange data with other systems such as client computing systems, websites on the Internet, corporate intranets, or other networks.

The operating system 1030, application programs 1032, other programs/modules 1034, drivers 1036, program data 1038 and server and/or browser 1040 can be stored on any other of a large variety of non-transitory processor-readable media (e.g., hard disk drive, optical disk drive, SSD and/or flash memory.

A client can enter commands and information via a pointer, for example through input devices such as a touch screen 1048, or via a computer mouse or trackball 1044 which controls a cursor. Other input devices can include a microphone, joystick, game pad, tablet, scanner, biometric scanning device, etc. These and other input devices (i.e., “I/O devices”) are connected to the processor(s) 1006 through an interface 1046 such as a touch-screen controller and/or a universal serial bus (“USB”) interface that couples user input to the system bus 1010, although other interfaces such as a parallel port, a game port or a wireless interface or a serial port may be used. The touch screen 1048 can be coupled to the system bus 1010 via a video interface 1050, such as a video adapter to receive image data or image information for display via the touch screen 1048.

The system 1000 operates in a networked environment using one or more of the logical connections to communicate with one or more remote computers, servers and/or devices via one or more communications channels, for example, one or more networks 1014a, 1014b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based system 1004 may include one or more network, wired or wireless communications interfaces 1052, 1056 (e.g., network interface controllers, cellular radios, Wi-Fi radios, Bluetooth radios) for establishing communications over the network, for instance the Internet 1014b or cellular network 1014a.

In a networked environment, program modules, application programs, or data, or portions thereof, can be stored in a server computing system (not shown). For convenience, the processor(s) 1006, system memory 1008, and network and communications interfaces 1052, 1056 are illustrated as communicably coupled to each other via the system bus 1010, thereby providing connectivity between the above-described components. In some embodiments, system bus 1010 may be omitted and the components are coupled directly to each other using suitable connections.

Other examples of the invention will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the invention being indicated by the following claims.

1. A method for de-duplicating bids for an advertising request in a real-time bidding online environment, comprising:
receiving an ad request from a requestor service;
creating a fingerprint based on metadata of the ad request;
determining if the fingerprint matches a pre-existing fingerprint within a database;
if the fingerprint does not match a pre-existing fingerprint, writing the fingerprint to the database;
holding an auction for bids from one or more ad buyers for the ad request associated with the fingerprint;
before or after the auction, receiving one or more additional ad request from the requestor service or a separate service;
creating an additional fingerprint for each of the one or more additional ad request;
determining if the additional fingerprint matches a pre-existing fingerprint within the database and, if a match is determined, designating the one or more additional ad request as a duplicate request and withholding the duplicate request from the auction;
comparing bids from the auction to identify a highest bid for the ad request associated with the fingerprint; and
submitting the highest bid to the requestor service.

2. The method of claim 1, wherein the fingerprint comprises a combination of elements of the metadata configured to verify a website and a user and to define attributes of the ad request.

3. The method of claim 1, wherein the fingerprint comprises a hash comprising at least two of an internet protocol (“IP”) address, uniform resource locator (“URL”), and a date and time.

4. The method of claim 1, wherein the database resides in shared memory across multiple servers configured to receive ad requests.

5. The method of claim 1, wherein bids received during the auction are stored in the database in association with the fingerprint.

6. The method of claim 1, wherein a no-bid is stored in the memory database when the auction yields no bids, and wherein the highest bid is the no-bid.

7. The method of claim 1, wherein withholding the duplicate request from the auction includes waiting long enough for the auction to complete, wherein the highest bid is also sent to the separate service.

8. The method of claim 1, wherein a highest number of bids including the highest bid are communicated to the requestor service.

9. The method of claim 1, further comprising configuring a processor to perform further processing wherein, if a match is determined, prior to withholding a duplicate request from an auction:
designating the duplicate request as a provisional duplicate and further processing the provisional duplicate to determine whether exceptions have been configured by one or more of the requestor service or the one or more ad buyers; and
if exceptions are found, advancing the provisional duplicate for inclusion in the auction.

10. The method of claim 9, wherein a user interface is configured by the requestor service to allow all provisional duplicates to be advanced for inclusion in the auction.

11. The method of claim 10, wherein the user interface is configured to allow provisional duplicates to advance to auction based on one or more of a timestamp within the fingerprint for the ad request, and a predetermined number of provisional duplicates.

12. A system for de-duplicating bids for an advertising request in a real-time bidding online environment, comprising:
a processor configured to execute instructions for de-duplicating ad requests, the instructions comprising:
receiving an ad request from a SSP;
creating a fingerprint based on metadata of the ad request;
determining if the fingerprint matches a pre-existing fingerprint within a database;
if the fingerprint does not match a pre-existing fingerprint, writing the fingerprint to the database;
holding an auction for bids from one or more DSPs for the ad request associated with the fingerprint;
before or after the auction, receiving one or more additional ad request from the SSP or another SSP;
creating an additional fingerprint for each of the one or more additional ad request;
determining if the additional fingerprint matches a pre-existing fingerprint within the database and, if a match is determined, designating the one or more additional ad request as a duplicate request and withholding the duplicate request from the auction;
comparing bids from the auction to identify a highest bid for the ad request associated with the fingerprint; and
submitting the highest bid to the SSP.

13. The system of claim 12, wherein the fingerprint comprises a combination of elements of the metadata configured to verify a website and a user and to define attributes of the ad request.

14. The system of claim 12, wherein the fingerprint comprises a hash comprising at least two of an internet protocol (“IP”) address, uniform resource locator (“URL”), and a date and time.

15. The system of claim 12, wherein the database resides in shared memory across multiple servers configured to receive ad requests.

16. The system of claim 12, wherein bids received during the auction are stored in the database in association with the fingerprint.

17. The system of claim 12, wherein a no-bid is stored in the memory database when the auction yields no bids, and wherein the highest bid is the no-bid.

18. The system of claim 12, wherein withholding the duplicate request from the auction includes waiting long enough for the auction to complete, wherein the highest bid is also sent to the separate SSP.

19. The system of claim 12, wherein a highest number of bids including the highest bid are communicated to the SSP.

20. The system of claim 12, further comprising configuring a processor to perform further processing wherein, if a match is determined, prior to withholding a duplicate request from an auction:
designating the duplicate request as a provisional duplicate and further processing the provisional duplicate to determine whether exceptions have been configured by one or more of the SSP or the one or more DSPs; and
if exceptions are found, advancing the provisional duplicate for inclusion in the auction.

21. The system of claim 20, wherein a user interface is configured by the SSP to allow all provisional duplicates to be advanced for inclusion in the auction.

22. The system of claim 21, wherein the user interface is configured to allow provisional duplicates to advance to auction based on one or more of a timestamp within the fingerprint for the ad request, and a predetermined number of provisional duplicates.

23. A method for de-duplicating bids for an advertising request in a real-time bidding online environment, comprising:
receiving an ad request from a SSP;
creating a fingerprint based on metadata of the ad request;
determining if the fingerprint matches a pre-existing fingerprint within a database;
if the fingerprint does not match a pre-existing fingerprint, writing the fingerprint to the database;
holding an auction for bids from one or more DSPs for the ad request associated with the fingerprint;
before or after the auction, receiving one or more additional ad request from the SSP or a separate SSP;
creating an additional fingerprint for each of the one or more additional ad request;
determining if the additional fingerprint matches a pre-existing fingerprint within the database and, if a match is determined:
designating the duplicate request as a provisional duplicate and further processing the provisional duplicate to determine whether exceptions have been configured by one or more of the SSP or the one or more DSPs; and
if exceptions are found, advancing the provisional duplicate for inclusion in the auction;
if exceptions are not found, designating the one or more additional ad request as a duplicate request and withholding the duplicate request from the auction;
comparing bids from the auction to identify a highest bid for the ad request associated with the fingerprint; and
submitting the highest bid to the SSP.

24. The method of claim 23, wherein the fingerprint comprises a combination of elements of the metadata configured to verify a website and a user and to define attributes of the ad request.

25. The method of claim 23, wherein the fingerprint comprises a hash comprising at least two of an internet protocol (“IP”) address, uniform resource locator (“URL”), and a date and time.

26. The method of claim 23, wherein the database resides in shared memory across multiple servers configured to receive ad requests.

27. The method of claim 23, wherein a user interface is configured by the SSP to allow all provisional duplicates to be advanced for inclusion in the auction.

28. The system of claim 27, wherein the user interface is configured to allow provisional duplicates to advance to auction based on one or more of a timestamp within the fingerprint for the ad request, and a predetermined number of provisional duplicates.

29. A method de-duplicating bids for an advertising request in a real-time bidding online environment, comprising:
receiving a first ad request from a requestor service;
creating a hash based on fields of the first ad request, including at least two of an at least two of an internet protocol (“IP”) address, uniform resource locator (“URL”), and a date and time;
determining if the hash already exists in an in-memory database;
when the hash does not already exist, writing the hash to the in-memory database;
holding an auction for bids for the ad request in association with the hash;
receiving a second ad request from the requestor service or a separate service;
abstaining from a second auction for bids on the second ad requests based on determining that a second hash created for the second ad request matches the first hash; and;
sending the highest bid to the requestor service.
